(19) United States
(12) Patent Application Publication
(10) Pub. No.: US 2010/0161786 A1
(43) Pub. Date: Jun. 24, 2010

(54) QOS CONTROL METHOD FOR ISCSI

(75) Inventors: Cang-Mou CAO, Tianjin (CN); Tom Chen, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/341,190

(22) Filed: Dec. 22, 2008

(51) Int. Cl. G06F 15/173

(52) U.S. Cl. 709/224

(57) ABSTRACT

A QoS control method for iSCSI supports QoS control between an initiator device and a target device, and includes the following steps. Preset two variables bucket and bucket_used. Receive a PDU sent from a connection. If the PDU carries or requests data, add lengths of data carried or requested by the PDU in the current one second and store the result to bucket_used. Determine whether bucket_used is larger than bucket or not. Rf yes, suspend the current QoS control object for iSCSI and accept no additional new PDU handling until the end of the current one second. Or otherwise, forward the PDU to an iSCSI PDU handler for subsequent execution. The QoS control method can perform a QoS control on different QoS control objects for iSCSI with a unified control granularity in the iSCSI service level, so that the complexity of the QoS control is greatly reduced.

### BACKGROUND OF THE INVENTION

1. Field of the Invention

The present invention relates to a quality of service (QoS) control method for an internet small computer systems interface (iSCSI), and more particularly to a QoS control method for the iSCSI, which is adapted to support a storage area network (SAN) including an initiator device and a target device and perform a QoS control on various QoS control objects for iSCSI and simplifying the QoS control process.

2. Related Art

The internet small computer systems interface (iSCSI) based on TCP/IP protocol is used for establishing and managing connections between an IP storage device, a host, and a client and creating a storage area network (SAN). The SAN enables a small computer systems interface (SCSI) protocol to be applied to high-speed data transmission networks. Such transmissions are performed among a plurality of data storage networks on a block level. The SCSI structure is based on a client/server mode and generally applied in an environment where the devices are close to each other and are connected by an SCSI bus. The main function of iSCSI is to perform encapsulating and reliable transmission for a large amount of data between a host system (initiator) and a storage device (target) over the TCP/IP network. Additionally, the iSCSI enables encapsulating SCSI commands over an IP network and runs over TCP.

The primary requirements for achieving data communication of the SAN concerned currently are listed as follows: 1. combination of data storage systems; 2. data backup; 3. server cluster; 4. copy; and 5. data recovery in emergencies. Besides, the SAN may be distributed across a plurality of local area networks (LANs) and wide area networks (WANs) at different geographic locations. Accordingly, it should be ensured that all the SAN operations are conducted safely and conform to the quality of service (QoS) requirements, and the iSCSI is just designed to accomplish the above requirements over the TCP/IP network.

Nowadays, with the rapid expansion of the storage market, the IP SAN has developed vigorously due to its advantages of being economic, easily deployed, as well as a desirable compatibility. Meanwhile, customers have an increasingly large demand for the IP SAN. As the 10G Ethernet has been proposed, the IP SAN competes with the traditional high-level Fibre Channel (FC). The foundation of the IP SAN is the iSCSI protocol.

Storage server products achieved through the iSCSI protocol are diversified and a storage server may be formed by one or more targets. In a storage session, an originator for initiating a request is referred to as an initiator and a requested handler is referred to as a target. Sessions can be divided into a discovery session and a normal session. A user establishes a discovery session through the initiator and the server to query the basic information of the server such as how many targets exist. The server returns those targets visible to the user to the initiator through the session. The user may also select one or more targets from the returned targets for login. Upon a successful login, the initiator establishes a normal session with a specific target, and thus the user can request and access the iSCSI.

However, currently, the iSCSI protocol does not provide a robust support for QoS and the QoS of the iSCSI service is generally achieved merely through the support from the lower layer protocol. Specifically, the iSCSI protocol is established on the basis of the TCP/IP protocol cluster, and thus the QoS of the iSCSI service is only achieved through the QoS over the TCP/IP protocol cluster.

As such, the QoS of the iSCSI service has certain defects in the prior art. Firstly, the iSCSI service needs to know the QoS control mode of the lower-layer TCP/IP protocol cluster. The user interface for the QoS varies for different operation systems, thereby causing inconveniences for a unified control of iSCSI services. Secondly, as the iSCSI service and the QoS implementation are carried out in different layers and the control granularities (sizes of the objects) are different as well, the complexity of the control process is severely increased. For example, as shown in FIG. 1, when it intends to perform a QoS control on an iSCSI session, since a single iSCSI session may use a plurality of connections such as TCP connection, the QoS controls for such connections need to be performed individually and coordinated for the iSCSI service, so that the complexity of the control process is severely increased.

In the granted U.S. Pat. No. 7,376,082, a method for providing quality of service (QoS) for an internet small computer systems interface (iSCSI) environment is presented, which is applied to a QoS system in an iSCSI environment including one or more initiators and one or more targets. Each initiator includes an iSCSI initiator and a TCP transport layer. The iSCSI initiator includes a QoS shaper 26 for shaping the iSCSI PDU according to QoS policies. The TCP transport layer includes a QoS marker for marking the PDU according to the QoS policies. The target includes a first and second QoS component. The first QoS component is in an iSCSI target and handles I/O resources. The first QoS component shapes read commands and write commands according to QoS policies. The second QoS component is in a TCP transport layer and handles network resources. The iSCSI PDUs are shaped and marked according to QoS policies of iSCSI. The QoS policies used by the initiator and the target include policies for network resources and policies for I/O resources.

### SUMMARY OF THE INVENTION

In order to solve the above problems in the prior art, the present invention is directed to a QoS control method for iSCSI, which is adapted to carry out QoS control on QoS control objects for iSCSI in the iSCSI service level. The QoS control objects for iSCSI include a session, a target, and an initiator.

The present invention provides a QoS control method for iSCSI, which includes the following steps.

First, two variables are preset. One variable is bucket (a bucket capacity), which indicates a traffic allowed by the QoS control object for iSCSI within one second, and the other is bucket_used (a used bucket capacity), which indicates a number of bytes already transmitted during the current one second.

Next, a PDU sent from a connection is received.

Then, if the received PDU carries or requests a data, lengths of the data carried or requested by the PDU during the current one second are added and then the obtained result is stored in the variable bucket_used.

Afterwards, it is determined whether the variable bucket_used is larger than the variable bucket or not, if yes, the current QoS control object for iSCSI is suspended, and no additional new PDU handling is accepted until the end of the current one second, or otherwise, the PDU is forwarded to an iSCSI PDU handler for subsequent execution.

The QoS control method for iSCSI provided by the present invention mainly aims at solving the QoS requirements from the iSCSI target, which further enables to perform the QoS control on various QoS control objects for iSCSI with a unified control granularity in the iSCSI service level, so that the complexity of the QoS control is greatly reduced.

### BRIEF DESCRIPTION OF THE DRAWINGS

The present invention will become more fully understood from the detailed description given herein below for illustration only, which thus is not limitative of the present invention, and wherein:

FIG. 1 is a schematic view of a system architecture for running a QoS control method for iSCSI in the prior art;

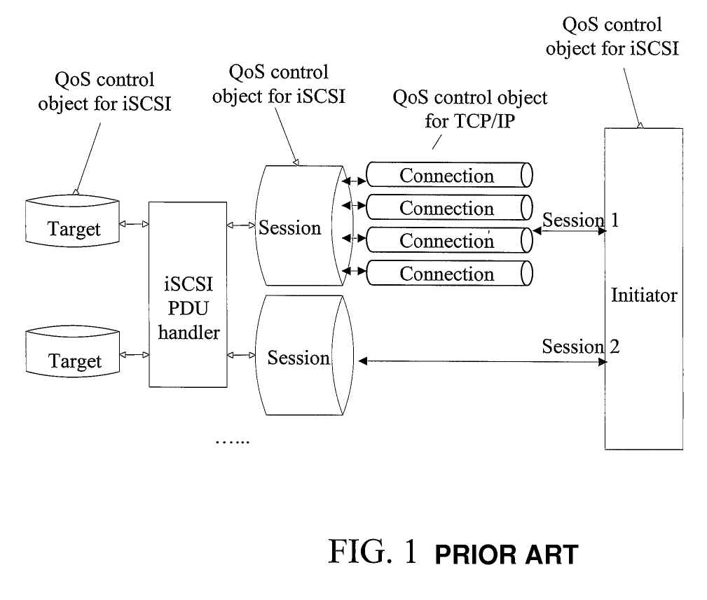

FIG. 2 is a relation diagram of QoS control objects for iSCSI according to the present invention;

FIG. 3 is a flow chart of a QoS control method for iSCSI according to a first embodiment of the present invention;

FIG. 4 is a flow chart of a QoS control method for iSCSI according to a second embodiment of the present invention; and

FIG. 5 is a flow chart of a QoS control method for iSCSI according to a third embodiment of the present invention.

### DETAILED DESCRIPTION OF THE INVENTION

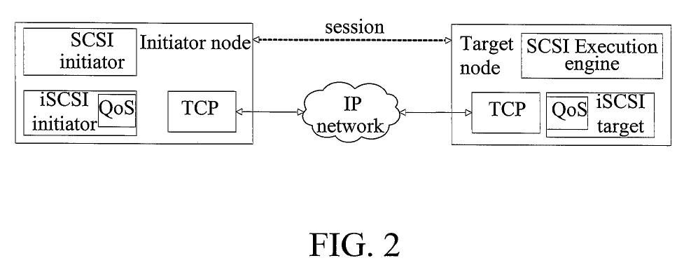

FIG. 2 is a relation diagram of QoS control objects for iSCSI according to the present invention. Referring to FIG. 2, the QoS control method for iSCSI according to the present invention enables to perform a QoS control on different QoS control objects for iSCSI in the iSCSI service level. The QoS control objects for iSCSI include a session, a target, and an initiator.

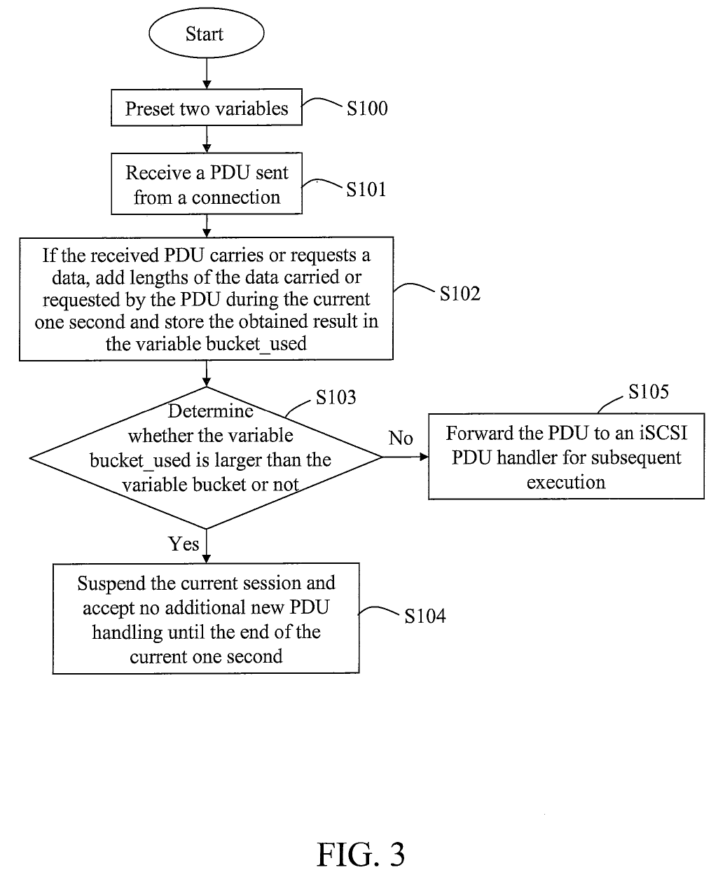

FIG. 3 is a flow chart of a QoS control method for iSCSI according to a first embodiment of the present invention. Referring to FIG. 3, the QoS control method for iSCSI according to the present invention can perform the QoS control by taking a session as a control object, which includes the following steps.

First, two variables are preset (Step S100). One variable is bucket (a bucket capacity, set by a user of a QoS system), which indicates a traffic allowed by the session within one second, and the other is bucket_used (a used bucket capacity), which indicates a number of bytes already transmitted during the current one second.

Next, a PDU sent from a connection is received (Step S101).

Then, if the received PDU carries or requests a data, lengths of the data carried or requested by the PDU during the current one second is added and then the obtained result is stored in the variable bucket_used (Step S102).

Afterwards, it is determined whether the variable bucket_used is larger than the variable bucket or not (Step S103), if yes, the current session is suspended, and no additional new PDU handling is accepted until the end of the current one second (Step S104), and if not, the PDU is forwarded to an iSCSI PDU handler for subsequent execution (Step S105).

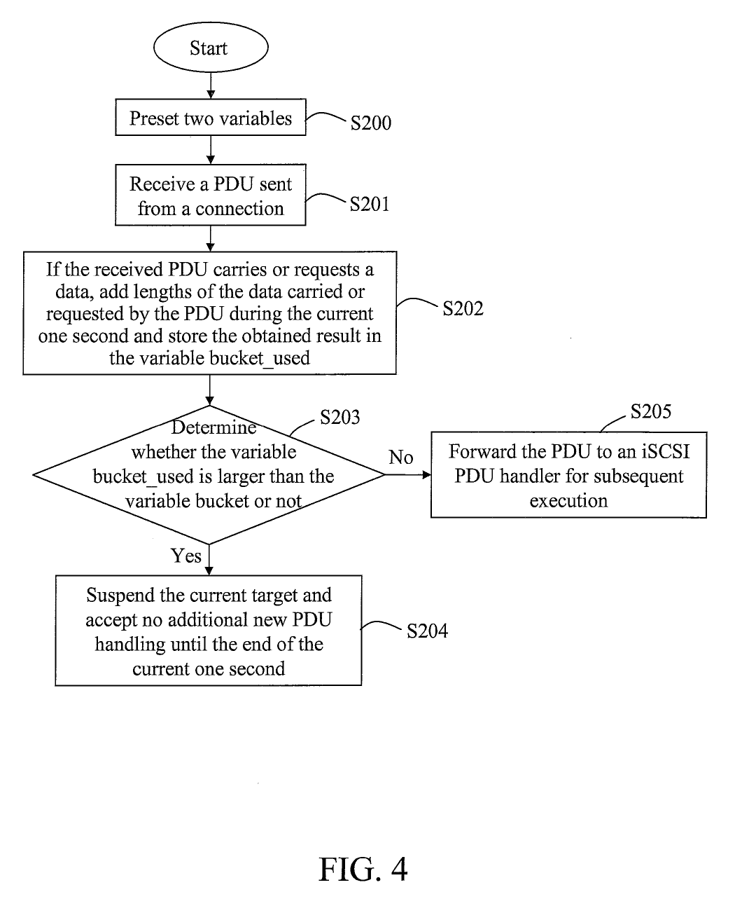

FIG. 4 is a flow chart of a QoS control method for iSCSI according to a second embodiment of the present invention. Referring to FIG. 4, the QoS control method for iSCSI according to the present invention can perform the QoS control by taking a target as a control object, which includes the following steps.

First, two variables are preset (Step S200). One variable is bucket (a bucket capacity, set by a user of a QoS system), which indicates a traffic allowed by the target within one second, and the other is bucket_used (a used bucket capacity), which indicates a number of bytes already transmitted during the current one second.

Next, a PDU sent from a connection is received (Step S201).

Then, if the received PDU carries or requests a data, lengths of the data carried or requested by the PDU during the current one second is added and then the obtained result is stored in the variable bucket_used (Step S202).

Afterwards, it is determined whether the variable bucket_used is larger than the variable bucket or not (Step S203), if yes, the current target is suspended, and no additional new PDU handling is accepted until the end of the current one second (Step S204), and if not, the PDU is forwarded to an iSCSI PDU handler for subsequent execution (Step S205).

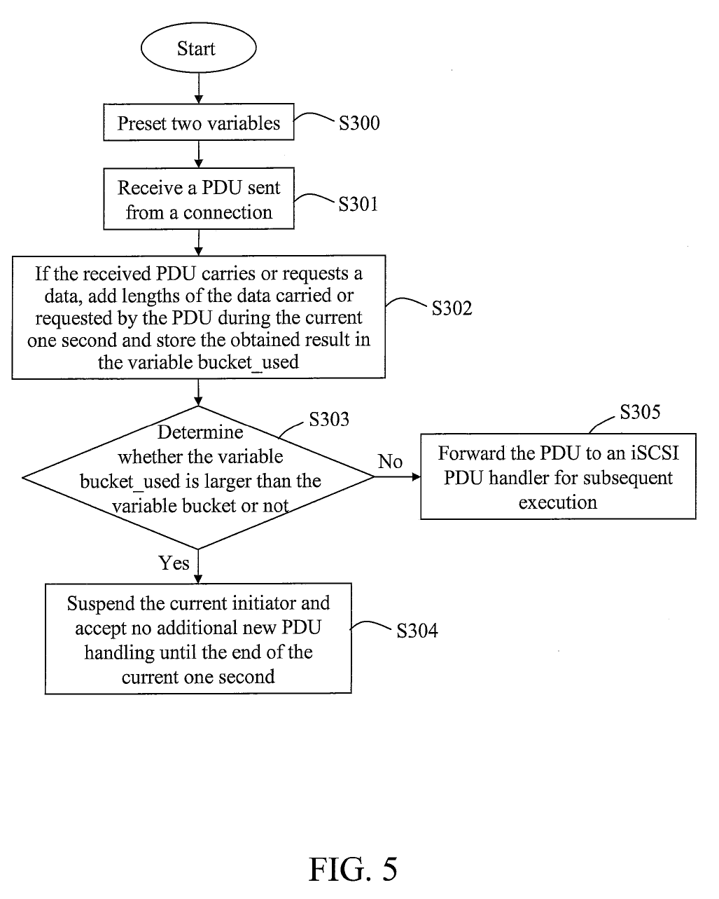

FIG. 5 is a flow chart of a QoS control method for iSCSI according to a third embodiment of the present invention. Referring to FIG. 5, the QoS control method for iSCSI according to the present invention can perform the QoS control by taking an initiator as a control object, which includes the following steps.

First, two variables are preset (Step S300). One variable is bucket (a bucket capacity, set by a user of a QoS system), which indicates a traffic allowed by the initiator within one second, and the other is bucket_used (a used bucket capacity), which indicates a number of bytes already transmitted during the current one second.

Next, a PDU sent from a connection is received (Step S301).

Then, if the received PDU carries or requests a data, lengths of the data carried or requested by the PDU during the current one second is added and then the obtained result is stored in the variable bucket_used (Step S302).

Afterwards, it is determined whether the variable bucket_used is larger than the variable bucket or not (Step S303), if yes, the current initiator is suspended, and no additional new PDU handling is accepted until the end of the current one second (Step S304), and if not, the PDU is forwarded to an iSCSI PDU handler for subsequent execution (Step S305).

What is claimed is:

1. A quality of service (QoS) control method for an internet small computer systems interface (iSCSI), comprising:
presetting two variables, wherein one of the two variables, bucket (a bucket capacity), indicates a traffic allowed by one QoS control object for iSCSI within one second, and the other variable, bucket used (a used bucket capacity), indicates a number of bytes actually transmitted during the current one second;
receiving a protocol data unit (PDU) sent from a connection;
if the received PDU carries or requests data, adding lengths of the data carried or requested by the PDU during the current one second and storing the obtained result in the variable bucket_used; and
determining whether the variable bucket_used is larger than the variable bucket or not, if yes, suspending a current QoS control object for iSCSI and accepting no additional new PDU handling until the end of the current one second, and if not, forwarding the PDU to an iSCSI PDU handler for subsequent execution.

2. The method according to claim 1, wherein the QoS control object for iSCSI is a session.

3. The method according to claim 1, wherein the QoS control object for iSCSI is a target.

4. The method according to claim 1, wherein the QoS control object for iSCSI is an initiator.

5. The method according to claim 1, wherein the variable bucket is set by a user of an iSCSI QoS system.

6. The method according to claim 1, wherein the connection is a TCP connection.
